(19) United States
(12) Patent Application Publication
(10) Pub. No.: US 2004/0076296 A1
(43) Pub. Date: Apr. 22, 2004

(54) Method for encrypting content, and method and apparatus for decrypting encrypted data

(76) Inventor: Toru Terauchi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/664,863

(22) Filed: Sep. 22, 2003

(30) Foreign Application Priority Data
Oct. 21, 2002 (JP) 2002-305970

(51) Int. Cl. H04N 7/167

(52) U.S. Cl. 380/201

(57) ABSTRACT

In a method of decrypting encrypted data, which is encrypted, based on an encryption key, the encrypted content data and operational rule information are supplied to a discriminating part. The operational rule information includes title key and reproduction object inherent information. The title key is uniquely determined in accordance with the content data, and the reproduction object inherent information restricts a reproduction of content data and includes item information for restricting a terminal. The item information is acquired from terminal side, and a reproduction possibility of the encoded content data is judged based on the terminal-side item information and the operational rule information. In a decryption key generation portion, a decryption key is generated from the item information and the title key in accordance with the judgment. In a decryption portion, the encrypted content data is decrypted based on the decryption key information.

### CROSS-REFERENCE TO RELATED APPLICATIONS

This application is based upon and claims the benefit of priority from the prior Japanese Patent Application No. 2002-305970, filed Oct. 21, 2002, the entire contents of which are incorporated herein by reference.

### BACKGROUND OF THE INVENTION

1. Field of the Invention

The present invention relates to a method of encrypting content data and a method of decrypting encrypted data, and more particularly to an encrypting/decrypting method utilized in a copyright protection mode in music or video distribution services.

2. Description of the Related Art

In recent years, with the spread of the Internet and mobile phone service, music or video content distribution services have been popularized. In such services, in order to avoid illegal copying of content to be distributed, a copyright protection scheme is incorporated.

In a copyright protection mode, generally, content is encrypted based on given key information and then distributed, and a legitimate user receives correct key information, and decrypts and reproduces the content based on this key information. When the encrypted content is illegally copied, disabling reception of the correct key information prevents the content from being correctly decrypted, thereby avoiding fraudulent reproduction.

In regular services, transmission/reception of additional information called operational rule information as well as the key information can restrict copy conditions or reproduction conditions of the distributed content. For example, in the case of restricting the number of times of reproduction, the number of times of possible reproduction is set in advance, and it is incorporated as the operational rule information. When distributing the content, the key information and the operation rule information are distributed with the encrypted content as a pair. At a distribution destination, the content is decrypted based on the received key information and reproduction is prepared. Further, at the same time, the operation rule information is analyzed, and the number of times of possible reproduction is checked. If the number of times of possible reproduction is not less than 1, reproduction processing is executed. At the same time, 1 is subtracted from the number of times of possible reproduction, and this value is reflected in the operational rule information. If the number of times of possible reproduction is 0, the reproduction processing is stopped. In this manner, it is possible to distribute content which can be reproduced for a previously specified number of times.

Since such key information or operational rule information is important information in the content distribution service, it is distributed in a mode additionally taking the security into consideration. For example, in the case of the Internet and the like, the operational rule information is encrypted and transmitted/received by using a mode called SSL (Secure Sockets Layer).

Usually, information called a title key is adopted in such a manner that the key information becomes unique in accordance with content, wherein the title key is generated by using a random number generator. Furthermore, combining the title key with any other information can restrict reproduction of the content at a specific terminal and the like. For example, a distributor obtains a serial number of a terminal as a target or object of reproduction, combines it with the title key in order to generate key information, and uses the key information to encrypt the content. The distributor distributes the title key and the encrypted content to a distribution destination. When reproducing the content at the distribution destination, the serial number given to the reproduction terminal is combined with the title key to generate the key information, and the key information is used to decrypt the content. Then, reproduction processing of the content is carried out. At this moment, if the reproduction terminal is a terminal which is not programmed on the distribution side, the key information generated based on the combination of the serial number given to the non-programmed terminal and the title key is fraudulent, and hence the content cannot be correctly decrypted.

Combining the title key with the inherent information as a restriction target or object in this manner can restrict a target or object which can be reproduced as content. As a restricted target or object, there can be assumed various cases, e.g., a case restricting a terminal which performs reproduction, a case restricting an individual who performs reproduction, a case restricting a medium on which information is stored, a case combining the formers, and others.

In the above-described prior art, however, when the reproduction object or object of the content is restricted, a judgment cannot be made upon whether the content reproduction conditions are satisfied until the content is decrypted. Furthermore, depending on the types of content, e.g., in case of a format that a judgment cannot be made when just checking the inside of data like PCM (Pulse Code Modulation) raw data, there is a problem that whether the decrypted result is correct cannot be judged.

### BRIEF SUMMARY OF THE INVENTION

It is an object of the present invention to provide an encrypting method which can assuredly judge whether reproduction conditions are satisfied without decrypting content when reproducing the content, and a decrypting method which decrypts the encrypted content.

According to an aspect of the present invention, there is provided a terminal apparatus for decrypting encrypted data including content, comprising:

providing part configure to providing terminal-side item information;

a first memory part configured to receive and store operational rule information corresponding to a combination of title key and reproduction object inherent information, the title key being uniquely determined in accordance with the content, and the reproduction object inherent information restricting a reproduction object of content and including item information;

a second memory part configured to receive and store the encrypted content data encrypted based to on encryption key information generated from the title key and the reproduction object inherent information;

a decryption key generation unit configured to compare the item information with the terminal-side item information to judge a reproduction possibility of the encrypted content data, and generate a decryption key from the item information and the title key in accordance with the judgment, the item information being acquired from the operational rule information; and

a decryption unit configured to decrypt the content data based on the decryption key information.

According to an another aspect of the present invention, there is provided a terminal for decrypting encrypted data including content, comprising:

providing part configure to provide terminal-side item information;

a first memory part configured to receive and store operational rule information corresponding to a combination of title key and encrypted keyword information, the title key being uniquely determined in accordance with the content, and the encrypted keyword information being encrypted based on reproduction object inherent information restricting a reproduction object of content and including item information;

a second memory part configured to receive and store the encrypted content data encrypted based to on encryption key information generated from the title key and the reproduction object inherent information;

a decryption key generation unit configured to compare the key word information with the terminal-side item information to judge a reproduction possibility of the encrypted content data, and generate a decryption key from the item information and the title key in accordance with the judgment, the key word information being acquired from the operational rule information; and

a decryption unit configured to decrypt the content data based on the decryption key information.

According to a yet another aspect of the present invention, there is provided an encryption apparatus for encrypting content data, comprising:

a receiving portion configured to receive terminal-side item information from the outside of the apparatus;

a first generation portion configured to acquire a title key which is uniquely determined in accordance with each content and the terminal-side item information and generates reproduction object inherent information which restricts a reproduction object of content;

a second generation portion configured to generate an encryption key information based on the title key and the reproduction object inherent information;

an encryption portion configured to encrypt the content data with utilizing the encryption key information; and

an output portion configured to generate content data file including the title key, the reproduction object inherent information and the encrypted content data and outputs the content data file. According to a further aspect of the present invention, there is provided an encryption apparatus for encrypting content data, comprising:

a receiving portion configured to receive terminal-side item information from the outside of the apparatus;

a first generation portion configured to acquire a title key which is uniquely determined in accordance with each content and the terminal-side item information and generates reproduction object inherent information which restricts a reproduction object of content;

a second generation portion configured to generate encryption key information based on the title key and the reproduction object inherent information, and generates encrypted keyword information obtained by encrypting the reproduction inherent information based on the encryption key information;

an encryption portion configured to encrypt the content data with utilizing the encryption key information to generate a encrypted content data file; and

an output portion configured to generate a operational rule information file including the title key, the encrypted keyword information and outputs the operational rule information file.

According to a yet further aspect of the present invention, there is provided a method of decrypting encrypted data including content, comprising:

preparing terminal-side item information;

receiving and storing operational rule information corresponding to a combination of title key and reproduction object inherent information, the title key being uniquely determined in accordance with the content, and the reproduction object inherent information restricting a reproduction object of content and including item information;

receiving and storing the encrypted content data encrypted based to on encryption key information generated from the title key and the reproduction object inherent information;

comparing the item information with the terminal-side item information to judge a reproduction possibility of the encrypted content data, and generating a decryption key from the item information and the title key in accordance with the judgment, the item information being acquired from the operational rule information; and

decrypting the content data based on the decryption key information.

According to a furthermore aspect of the present invention, there is provided a method of decrypting encrypted data including content, comprising:

providing terminal-side item information;

receiving and storing operational rule information corresponding to a combination of title key and encrypted keyword information, the title key being uniquely determined in accordance with the content, and the encrypted keyword information being encrypted based on reproduction object inherent information restricting a reproduction object of content and including item information;

receiving and storing the encrypted content data encrypted based to on encryption key information generated from the title key and the reproduction object inherent information;

comparing the key word information with the terminal-side item information to judge a reproduction possibility of the encrypted content data, and generating a decryption key from the item information and the title key in accordance with the judgment, the key word information being acquired from the operational rule information; and

decrypting the content data based on the decryption key information.

According to a yet furthermore aspect of the present invention, there is provided an encryption method of encrypting content data, comprising:

receiving terminal-side item information from the outside;

acquiring a title key which is uniquely determined in accordance with each content and the terminal-side item information and generating reproduction object inherent information which restricts a reproduction object of content;

generating an encryption key information based on the title key and the reproduction object inherent information;

encrypting the content data with utilizing the encryption key information to generate a encrypted content file; and

generating operational rule information file including the title key, and the reproduction object inherent information and outputs the operational rule information file.

According to a yet furthermore aspect of the present invention, there is provided an encryption method of encrypting content data, comprising:

receiving terminal-side item information from the outside;

acquiring a title key which is uniquely determined in accordance with each content and the terminal-side item information and generating reproduction object inherent information which restricts a reproduction object of content;

generating encryption key information based on the title key and the reproduction object inherent information, and generating encrypted keyword information obtained by encrypting the encryption key information based on the reproduction inherent information;

encrypting the content data with utilizing the encryption key information; and

generating content data file including the title key, the encrypted keyword information and the encrypted content data and outputting the content data file.

### BRIEF DESCRIPTION OF THE SEVERAL VIEWS OF THE DRAWING

FIG. 1 is an explanatory view showing a function block used to realize a method of encrypting content according to a first embodiment of the present invention;

FIG. 2 is an explanatory view showing a function block used to realize a decrypting method of decrypting encrypted content according to the embodiment of the present invention;

FIGS. 3A and 3B flowcharts showing an encrypting method of content according to the embodiment of the present invention;

FIG. 4 is a plane view showing a format of operation rule information created by the method illustrated in FIG. 3;

FIGS. 5A and 5B are explanatory views showing a function block used to realize an encrypting method of content according to another embodiment of the present invention;

FIG. 6 is an explanatory view showing a function block used to realize a decrypting method of decrypting encrypted content according to the embodiment of the present invention;

FIGS. 7A and 7B are flowcharts showing an encrypting method of content according to the embodiment of the present invention;

FIG. 8 is a plane view showing a format of operational rule information created by the method depicted in FIGS. 7A and 7B; and

FIG. 9A and 9B are explanatory views showing a function block used to realize a decrypting method which decrypts encrypted content according to the embodiment of the present invention.

### DETAILED DESCRIPTION OF THE INVENTION

An encrypting method for content and a decrypting method for decrypting encrypted content according to an embodiment of the present invention will now be described hereinafter with reference to the accompanying drawings.

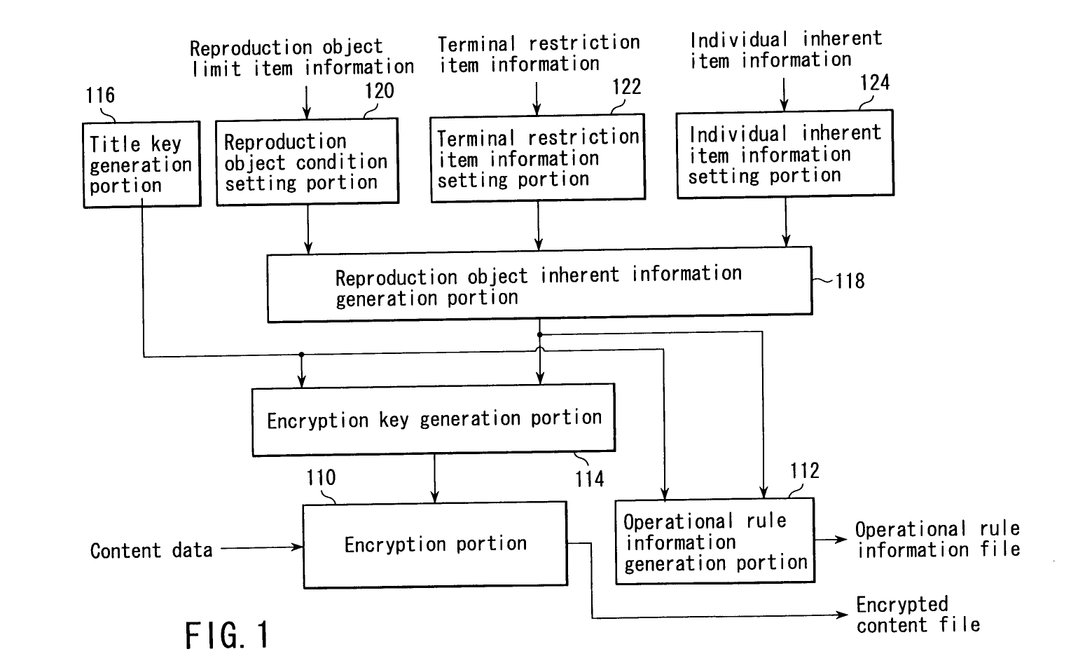

FIG. 1 shows content encryption processing circuit in the form of a function block illustrating a circuit configuration used for encryption processing according to an embodiment of the present invention. In the circuit of FIG. 1, content data is input to and encrypted in an encryption portion 110 to produce an encrypted content file. The encrypted content file is output from the encryption portion 110. An operational rule information file relating to the encrypted content file is generated in an operational rule information generation portion 112, and the operational information file is output from the operational rule information generation portion 112. The content data is encrypted in the encryption portion 110 based on an encryption key generated by an encryption key generation portion 114. This encryption key is generated by the encryption key generation portion 114 based on a title key determined in accordance with each title of the content and reproduction object inherent information. Here, the title key is generated in accordance with each title in a title key generation portion 116. The reproduction object inherent information is generated by supplying individual inherent item information to a reproduction object inherent information generation portion 118 from an individual inherent item information setting portion 124 which restricts reproduction of content based on a reproduction object condition from a reproduction object condition setting portion 120 which sets a reproduction object condition corresponding to a distribution condition of the content, terminal restriction item information from a terminal restriction item information setting portion 122 which restricts a device or terminal which reproduces the content, and information inherent to an individual. A memory areas in a memory to which reproduction object restriction item information, terminal information and individual inherent item information are supplied through an input/output portion (not shown) correspond to the reproduction object condition setting portion 120, the terminal restriction item information setting portion 122 and the individual inherent item information setting portion 124. Further, information supplied to the reproduction object inherent information generation portion 118 is not restricted to such information, it may be substituted by any other information, or other information may be added to this information.

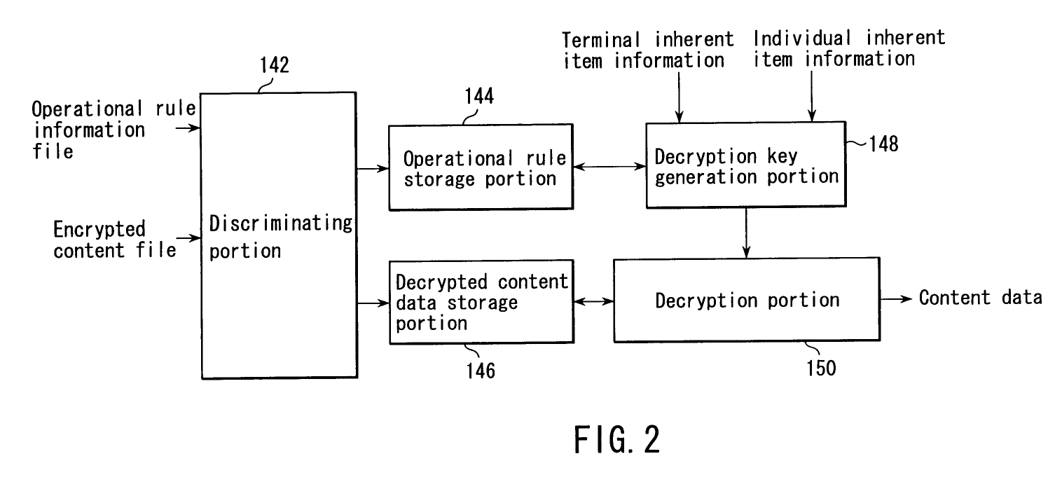

FIG. 2 shows a circuit configuration of a terminal apparatus, which processes the encrypted content file and the operational rule information file relating to the encrypted content file from content encryption processing circuit shown in FIG. 1, in the form of a function block. The encrypted content file and the operational rule information file relating to the encrypted content file are supplied via a communication network such as the Internet and supplied to a discriminating portion 142 through an input/output terminal (not shown) of a terminal. The encrypted content file and the operational rule information file are discriminated in the discriminating portion 142. The content data file is stored in encrypted content data storage portion 146, and the operational rule information file is stored in an operational information storage portion 144. These storage portions usually correspond to memory areas in the memory. To an decryption key generation portion 148 shown in FIG. 2 are supplied inherent information of the terminal and individual information input from the terminal, and the decryption key generation portion 148 generates a decryption key from the terminal inherent information, the individual information and the operational information, as will be described later. A decryption portion 150 decrypts the encrypted content data in the content data file stored in the storage portion 146 with utilizing a decryption key generated in the encryption key generation portion 148 and outputs the content data, this data is further converted into a sound signal and a video signal in a non-illustrated conversion portion and reproduced as sound/video content.

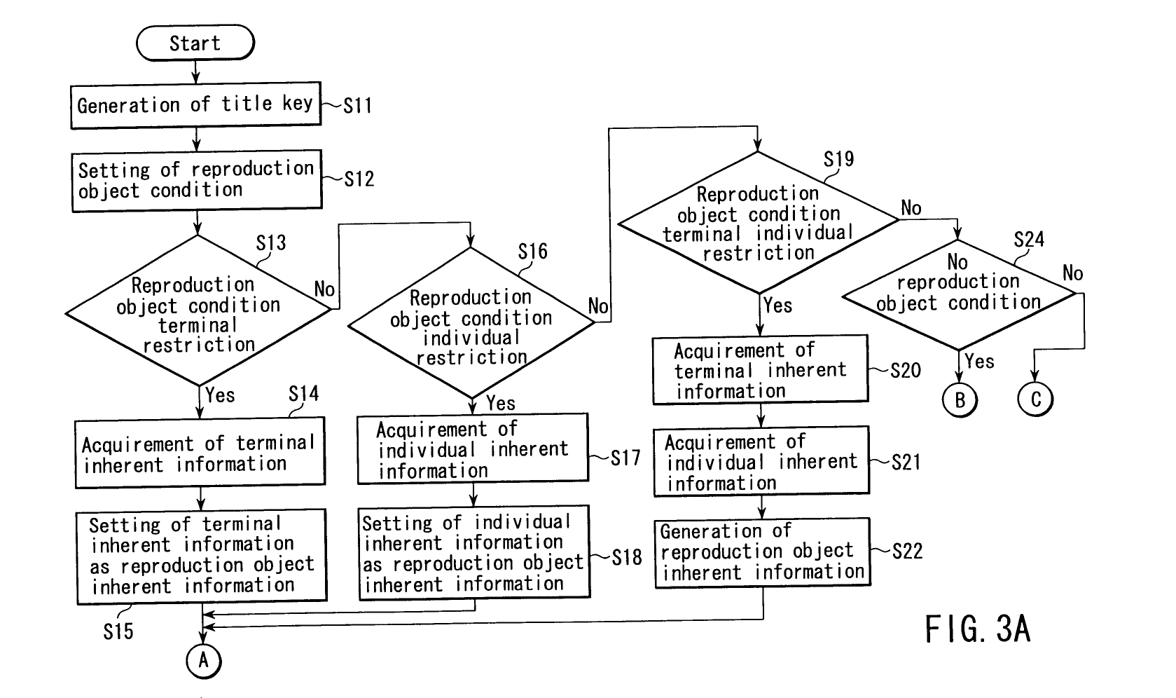

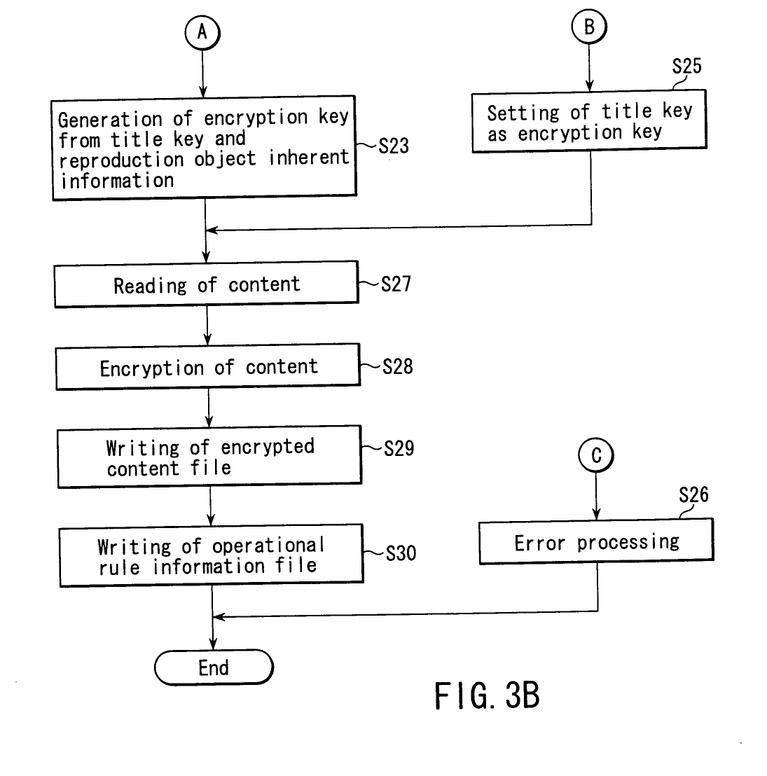

Processing in the content encryption processing circuit and the terminal circuit depicted in FIGS. 1 and 2 will now be described with reference to FIGS. 3 to 5.

FIG. 3 is a flowchart showing a procedure of encryption processing according to the embodiment of the present invention. In the procedure of encrypting the content, data having a fixed length which is uniquely determined in accordance with each content is first generated as a title key in the title key generation portion 116, as shown in step S11. For example, random number data consisting of 64 bits is generated by using the random number generator, and it is determined as a title key. Then, as shown in step 12, the reproduction object condition setting portion 120 sets a reproduction object condition which determines whether a reproduction object of the content is restricted or which combination is used to apply restriction in case of performing restriction. This reproduction object condition is arbitrary determined by content distributor (content provider) in accordance with each content. Then, as shown in step S13, a judgment is made upon whether the set reproduction object condition is restricted to the terminal. If the condition is restricted to the terminal, the inherent information of the terminal is obtained in the terminal restriction item information setting portion 122 as shown in step S14. As the inherent information of the terminal, there is, e.g., a serial number and the like of the terminal, and information uniquely determined in accordance with each terminal is utilized as inherent information. As shown in step S15, the obtained terminal inherent information is set as reproduction object inherent information.

If the set reproduction object condition is not restricted to the terminal at the step S13, whether the set reproduction object condition is restricted to an individual is likewise judged in step S16. If this condition is restricted to the individual, as shown in step S17, the inherent information of the individual is obtained in the individual inherent item information setting portion 124. As this individual information, there is, e.g., a credit card number, and information uniquely determined in accordance with each individual is utilized as the inherent information. The obtained individual inherent information is set as the reproduction object inherent information in step S18.

If the set reproduction object condition is not restricted to the individual at the step S16, a judgment is made upon whether the set reproduction object condition is restricted to a combination of the terminal and the individual as shown in step S19. If this condition is restricted to a combination of the terminal and the individual, the inherent information of the terminal as a target or object is obtained and the inherent information of the individual is acquired as shown at steps S20 and S21. The reproduction object inherent information is generated in the reproduction object inherent information generation portion 118 based on the obtained inherent information of the terminal and the acquired inherent information of the individual as shown in step S22. As this reproduction object inherent information, there is, e.g., an arithmetic operation result obtained by subjecting the terminal inherent information and the individual inherent information to XOR arithmetic operation processing, and this arithmetic operation result is set as the reproduction object inherent information.

If the reproduction object condition is restricted in any one of step S13, the step S16 and the step S19, the encryption key is generated from the title key and the reproduction object inherent information in the encryption key generation portion 114 as shown in step S23. As this encryption key, there is, e.g., an arithmetic operation result obtained by subjecting the title key and the reproduction object inherent information to the XOR arithmetic operation processing, and this arithmetic operation result is determined as the encryption key.

If the set reproduction object condition is not restricted to a combination of the terminal and the individual at the step S19, a judgment is made upon whether the set reproduction object condition has no restriction as shown in step 24. If the reproduction object is not restricted, the title key is set as the encryption key as it is in step S25.

If the set reproduction object condition is other than those above at the step S24, error processing is executed as a judgment processing error as shown in step S26, thereby terminating the processing.

When the encryption key is set at the step S23, the content is read in the encryption portion 110 as shown in step S27, and the content is subjected to encryption processing by using the encryption key as shown in step S28. Thereafter, as shown in step S29, the encrypted content is written in the encrypted content file in the encryption portion 110 as shown in step S29, and the reproduction object inherent information and the title key are written as the operational rule information file in the operational rule information file in step S30.

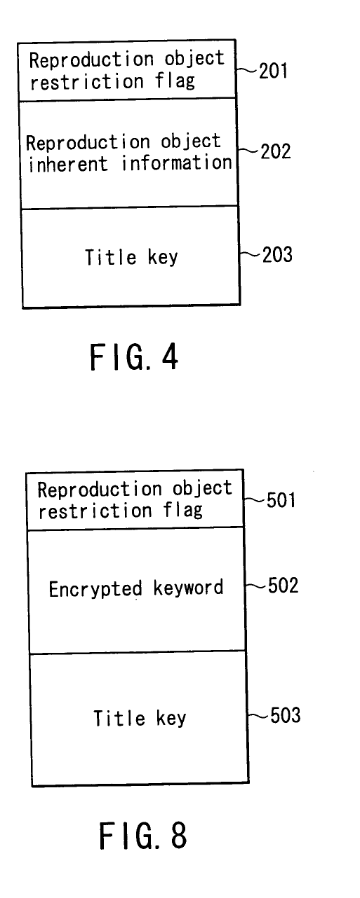

FIG. 4 shows a data structure of the operational rule information file generated by the encryption processing. The operational rule information file is provided with a flag 201 indicating that whether the reproduction object condition is restricted, reproduction object inherent information 202 and a title key 203. When the reproduction object is restricted, 1 is set to the reproduction object restriction flag, and this flag “1” indicates that the reproduction object inherent information is enabled. On the contrary, when the reproduction object is not restricted, 0 is set to the reproduction object restriction flag, and the reproduction object inherent information becomes indefinite by this flag “0”. The encrypted data generated by the encryption processing and the operational rule information is distributed to the reproduction terminal by a method previously determined in accordance with a service.

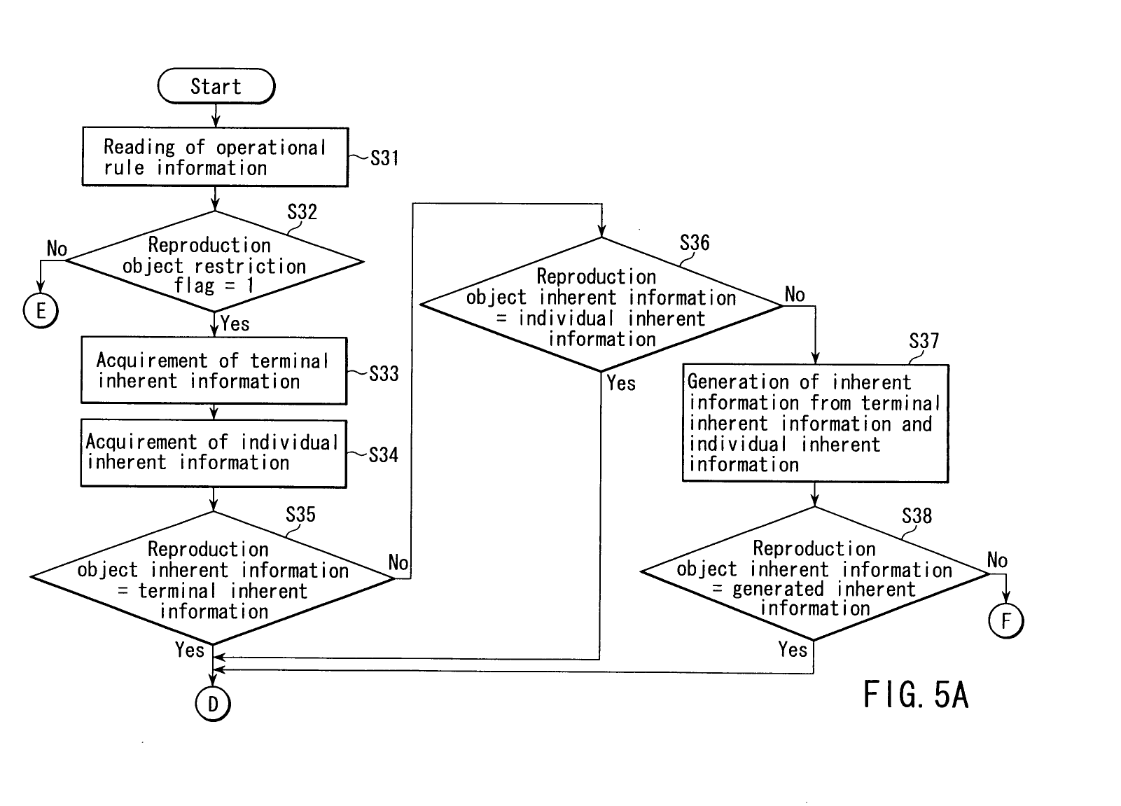

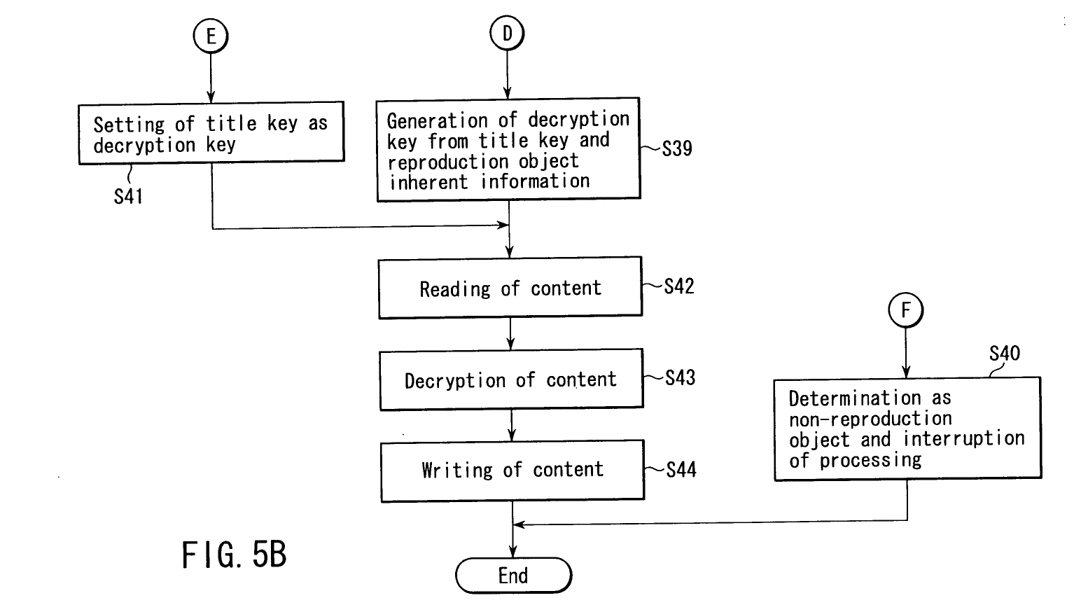

In the reproduction terminal, the content encrypted in accordance with such a procedure as shown in FIG. 5 is subjected to decryption processing.

In the reproduction terminal, the operational rule information file and the encrypted content file are input to the discriminating portion 142, and the operational rule information file and the encrypted content data file are discriminated. The operational rule information file and the encrypted content file are respectively stored in the operational rule information storage portion 144 and the encrypted content data storage portion 146. In the decryption key generation portion 148, the distributed operational rule information is first read as shown in step S31. Then, in step S32, the reproduction object restriction flag is extracted from the read operational rule information, and a judgment is made upon whether the reproduction object restriction flag is set to 1. If 1 is set to the flag, it is determined that the reproduction object is restricted. Therefore, as shown in step S33, the terminal inherent information is input from the reproduction terminal to the encryption key generation portion 148. Moreover, as shown in step S34, the individual inherent item information is input to the decryption key generation portion 148.

Subsequently, the reproduction object inherent information is extracted from the read operational rule information, and a judgment is made upon whether the reproduction object inherent information matches with the terminal inherent information as shown in step S35. If they do not match with each other, a judgment is likewise made upon whether the reproduction object inherent information matches with the individual inherent item information as shown in step S36. If the reproduction object inherent information does not match with the individual inherent item information, in step S37, the inherent information is generated from the terminal inherent information and the individual inherent item information in the decryption key generation portion 148. For example, the terminal inherent information and the individual inherent item information are subjected to the XOR arithmetic operation processing and its arithmetic operation result is obtained as the inherent information as already described above. Then, in step S38, a judgment is made upon whether the reproduction object inherent information matches with the generated inherent information. If the reproduction object inherent information in the operational rule information matches with any of the above conditions at any one of the steps S35, S36 and S38, it is determined that this information is the reproduction object, and the decryption key is generated from the title key in the operational rule information and the reproduction object inherent information by the decryption key generation portion 148 in step S39. For example, the title key and the reproduction object inherent information are subjected to the XOR arithmetic operation processing, and its arithmetic operation result is determined as the decryption key. As shown in step S38, when the reproduction object inherent information does not match with any condition, it is determined that this information is not the reproduction object and the decryption processing is stopped in step S40. If the reproduction object restriction flag of the operational rule information is not 1, at the step S41, the title key of the operational rule information is set as the decryption key as it is in the decryption key generation portion 148. Then, when the decryption key is set, the encrypted content is read as shown in step S42, and the content is decrypted by using the decryption key in the decryption portion 150 as shown in step S43. Thereafter, in step S44, the decrypted content is written, and the processing is terminated.

In the above-described embodiment, description has been given on the assumption that the condition to restrict the reproduction object is any one of no restriction, restriction to the terminal, restriction to the individual and restriction to the terminal and the individual, but the restriction condition is not restricted thereto. It is apparent that it may be substituted by any other restriction condition or any other restriction condition may be added to this condition.

According to the encryption method of the content and the decryption method of decrypting the encrypted content of the foregoing embodiment, when the content is encrypted, the inherent information used to restrict the reproduction object is incorporated into the operational rule information as the reproduction object inherent information and distributed together with the encrypted content. Additionally, when the content is decrypted, it is possible to assuredly judge whether the reproduction condition is satisfied by comparing the reproduction object inherent information in the operational rule information with various kinds of inherent information from which reproduction is effected, and the reproduction condition can be judged without subjecting the content to the decryption processing. Therefore, the encrypted content which can increase efficiency of the processing can be distributed, and efficiency of the processing relative to the encrypted content can be increased.

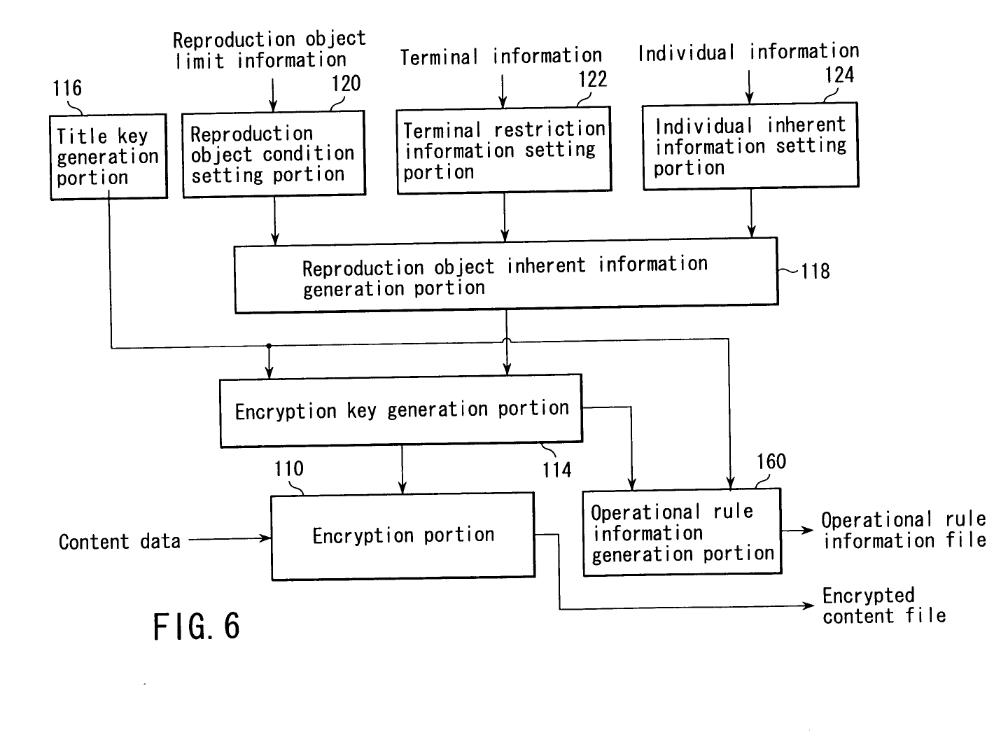

Description will now be given as to an encryption method of content and a decryption method of decrypting encrypted content according to another embodiment of the present invention with reference to FIGS. 6 to 9.

FIG. 6 shows content encryption processing circuit in the form of a function block illustrating a circuit configuration used for encryption processing according to another embodiment of the present invention. Since the function block circuit shown in FIG. 6 is substantially equal to the function block circuit illustrated in FIG. 1, like reference numerals denote parts equal to those in FIG. 1, thereby eliminating their explanation.

In the content encryption processing circuit shown in FIG. 6, an operational rule information generation portion 160 for generating an operational rule information file is provided in place of the operational rule information generation portion 112. That is, an encryption key is generated by the encryption key generation portion 114 based on the reproduction object inherent information from the reproduction object inherent information generation portion 118 and the title key from the title key generation portion 116, the title key is encrypted into an encryption key word by using this encryption key in the operational rule information generation portion 160, the encryption key word is written in an operational rule information together with the title key and the operational rule information file is output from the operational rule information generation portion 160.

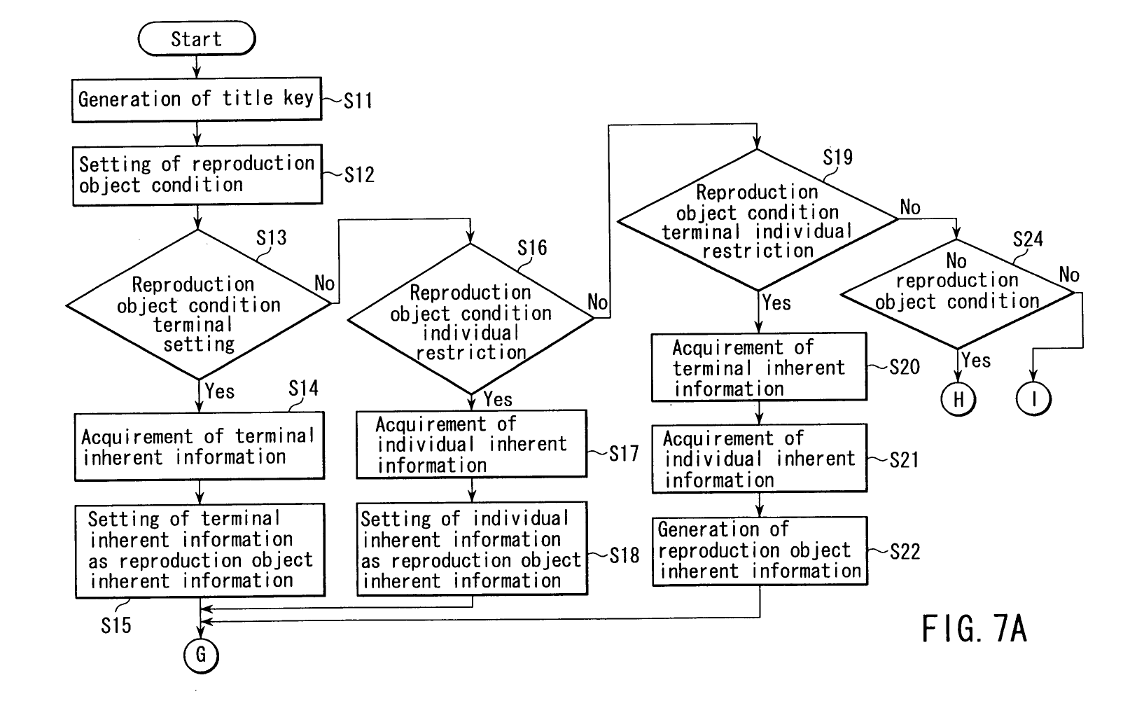

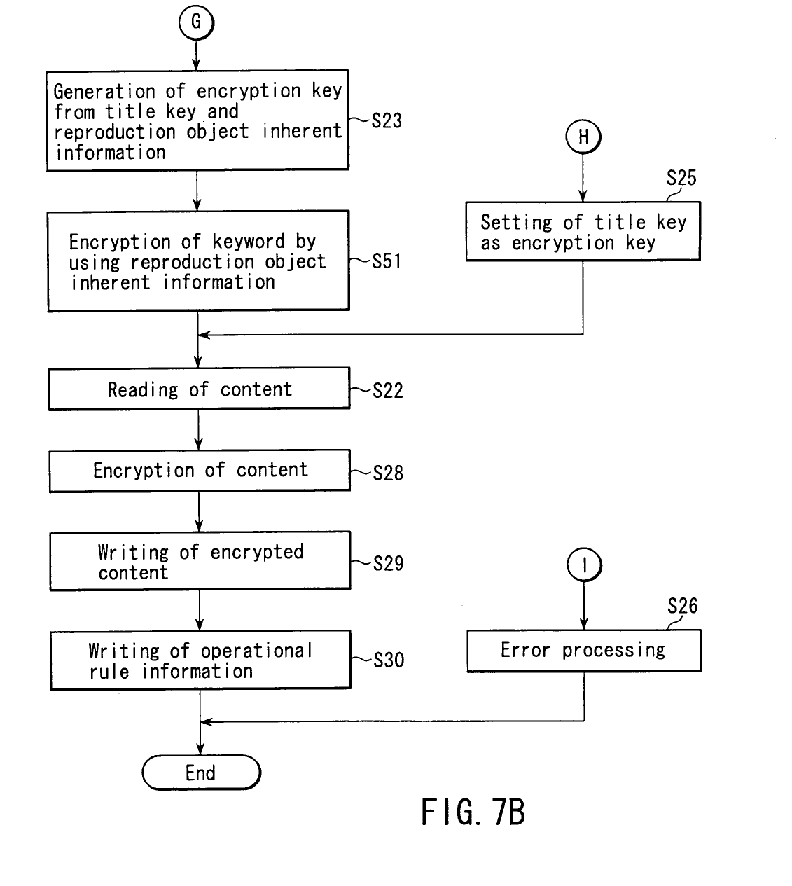

The encryption processing in the content encryption processing circuit illustrated in FIG. 6 will now be described with reference to FIGS. 7A and 7B which is a flowchart showing an encryption processing procedure.

The procedure to encrypt the content illustrated in FIGS. 7A and 7B is executed in substantially the same procedure of the encryption processing according to the first embodiment described in conjunction with FIGS. 1 to 3. Therefore, in FIGS. 7A and 7B, as to the processing having the same reference numeral as that illustrated in FIG. 3, it is determined that the same processing is executed, thereby eliminating its explanation.

In the encryption method of the content according to this embodiment, the steps S11 to S23 are executed, the reproduction object condition is restricted, and the encryption key is generated from the title key and the reproduction object inherent information. Thereafter, as different from the first embodiment, a predetermined keyword having the reproduction object inherent information as a key is encrypted in the encryption key generation portion 114 in step S51. For example, a keyword value 0×12345678 is encrypted with the reproduction object inherent information being used as the key. Then, the processing at the steps S27 to S30 is likewise executed, the encrypted content is written in the content file in the encryption portion, and the encrypted keyword information and the title key are written in the operational rule information file in the operational rule information generation portion 160.

FIG. 8 shows a data structure of the operational rule information file generated by the encryption processing. The operational rule information file is provided with a flag 501 indicating that whether the reproduction object condition is restricted, encrypted keyword information 502, and a title key 503. In case of restricting the reproduction object, 1 is set to the reproduction object restriction flag, and this flag “1” indicates that the encrypted keyword information is enabled. On the contrary, when the reproduction object is not restricted, 0 is set to the reproduction object restriction flag, and the encrypted keyword information becomes indefinite by this flag “0”. The encrypted data generated by the encryption processing and the operational rule information is distributed to the reproduction terminal by a method previously determined in accordance with a service.

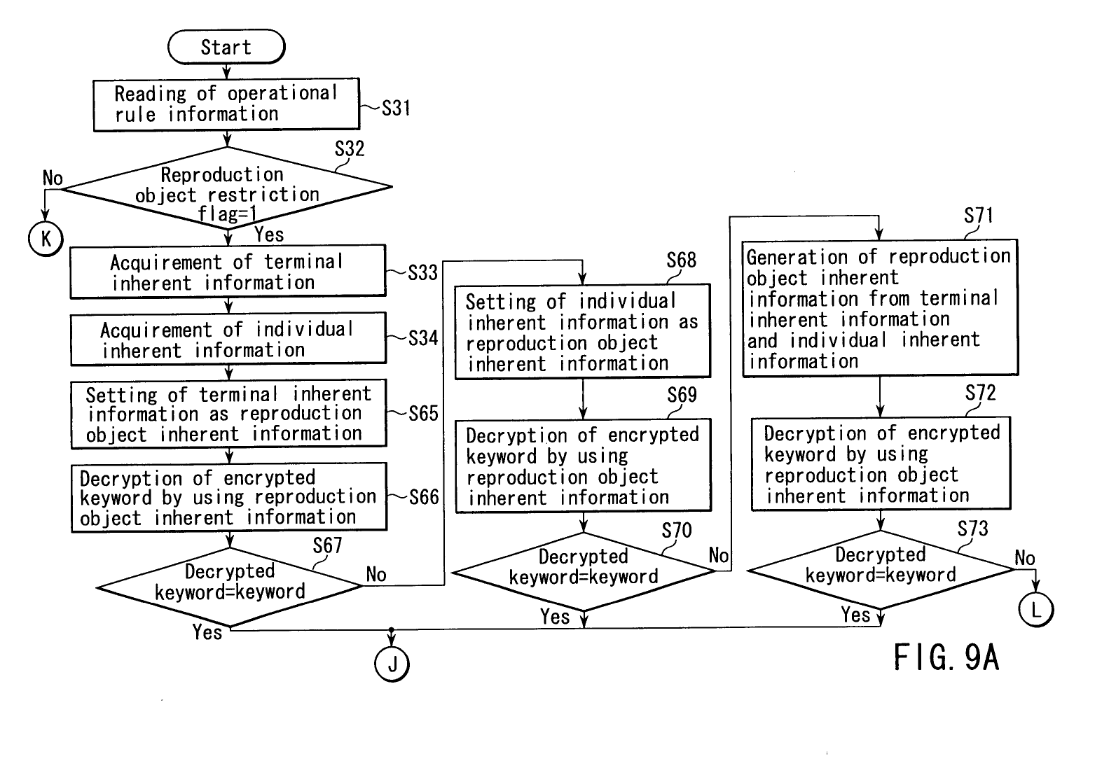

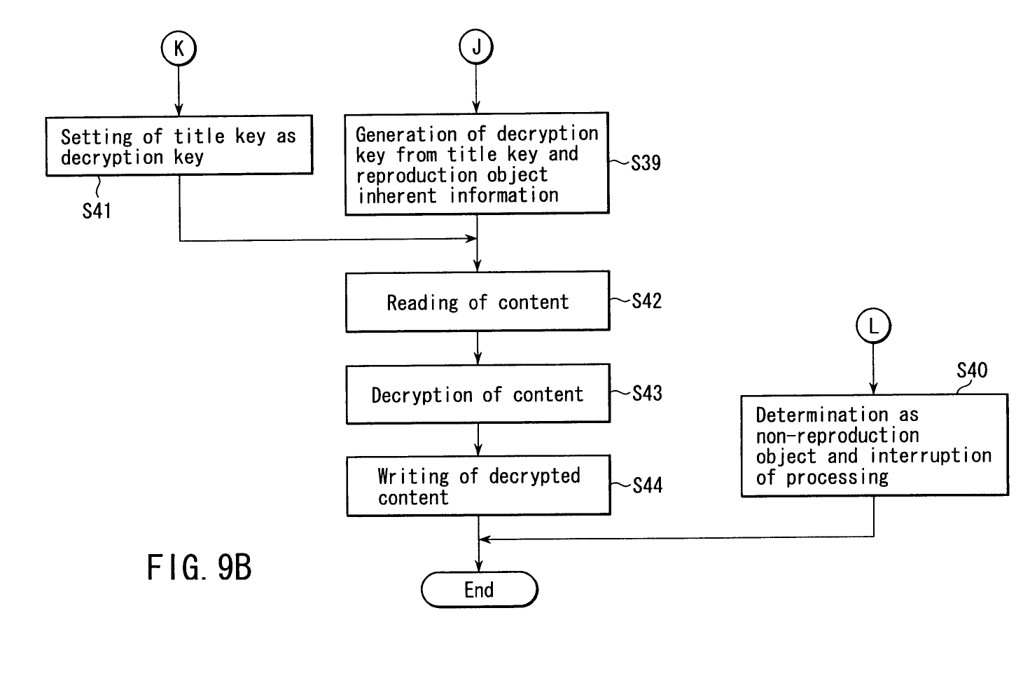

In the reproduction terminal shown in FIG. 2, the encrypted content is subjected to the decryption processing in accordance with such a procedure as shown in FIG. 9. In the processing shown in FIG. 9, as to the processing having the same reference numeral as that illustrated in FIG. 3, it is determined that the same processing is executed since the same processing at that depicted in FIG. 3 is included, and its explanation will be briefly given.

First, in step S31, the distributed operational rule information is read. Then, in step S32, the reproduction object restriction flag is extracted from the operational rule information file read into the operational information storage portion 144 by the decryption key generation portion 148, and a judgment is made upon whether the reproduction object restriction flag is set to 1 at the step S32. If 1 is set to the flag, it is determined that the reproduction object is restricted, the terminal inherent information is input from the reproduction terminal into the decryption key generation portion 148 at the step S33, and the individual inherent item information is likewise input at the step S34.

Here, in the processing at the step S65, the terminal inherent information is set as the reproduction object inherent information in the decryption key generation portion 148 as shown in step S65. Then, in step S66, the encrypted keyword information in the operational rule information is subjected to the decryption processing with the reproduction object inherent information being used as a key in the decryption key generation portion 148. Further, as a step S67, a judgment is made upon whether the decrypted keyword information matches with previously determined keyword information, e.g., 0×12345678. If the both do not match with each other, the individual inherent item information is set as the reproduction object inherent information in step S68. Then, in step S69, the encrypted keyword information in the operational rule information file is subjected to the decryption processing with the reproduction inherent information being used as a key in the decryption key generation portion 148. In step S70, a judgment is made upon whether the decrypted keyword information matches with the previously determined keyword information. If the both do not match with each other, in step S71, the reproduction object inherent information is generated from the terminal inherent information and the individual inherent item information in the decryption key generation portion 148. For example, an arithmetic operation result obtained by subjecting the terminal inherent information and the individual inherent item information to the XOR arithmetic operation processing is determined as the reproduction object inherent information. In step S72, with the reproduction object inherent information being used as a key, the encrypted keyword information in the operational rule information is subjected to the decryption processing in the decryption key generation portion 148. In step S73, a judgment is made upon whether the decrypted keyword information matches with the previously determined keyword information.

If the keyword is decrypted from the encrypted keyword under any condition at the steps S67, S70 and S73, it is determined that the keyword is the reproduction object, and the decryption key is generated from the title key in the operational rule information and the reproduction object inherent information at the step S39. For example, an arithmetic operation result obtained by subjecting the title key and the reproduction object inherent information to the XOR arithmetic operation processing is determined as the decryption key. If the information does not match with any condition at the steps S67, S70 and S73, it is determined that this information is not the reproduction object in the decryption key generation portion 148. At the step S40, the decryption processing is interrupted. If the reproduction object restriction flag of the operational rule information is not 1 at the step S32, the title key of the operational rule information is set as the decryption key as it is at the step S41. If the decryption key is set at the step S41 or S39, the encrypted content is read into the decryption portion 150 at the step S42, and the content is decrypted with utilizing the decryption key at the step S43. Thereafter, at the step S44, the decrypted content is written, thereby terminating the processing.

In this embodiment, although description has been given on the assumption that the condition to restrict the reproduction object is any of no restriction, restriction to the terminal, restriction to the individual and restriction to the terminal and the individual, the restriction condition is not restricted thereto. Furthermore, it is apparent that this condition may be substituted by any other restriction condition or any other restriction condition may be added to this condition.

According to this embodiment shown in FIGS. 6 to 9, when encrypting the content, the keyword is encrypted with the inherent information used to restrict the reproduction object being used as the key, and it is incorporated into the operational rule information and distributed together with the encrypted content. Moreover, when decrypting the content, it is possible to correctly judge whether the reproduction condition is satisfied by judging whether the encrypted keyword in the operational rule information can be correctly decrypted with various kinds of inherent information from which reproduction is carried out being used as the key. Therefore, the encrypted content which can increase efficiency of the processing can be distributed, and efficiency of the processing relative to the encrypted content can be increased.

What is claimed is:

1. A terminal apparatus for decrypting encrypted data including content, comprising:
providing part configure to providing terminal-side item information;
a first memory part configured to receive and store operational rule information corresponding to a combination of title key and reproduction object inherent information, the title key being uniquely determined in accordance with the content, and the reproduction object inherent information restricting a reproduction object of content and including item information;
a second memory part configured to receive and store the encrypted content data encrypted based to on encryption key information generated from the title key and the reproduction object inherent information;
a decryption key generation unit configured to compare the item information with the terminal-side item information to judge a reproduction possibility of the encrypted content data, and generate a decryption key from the item information and the title key in accordance with the judgment, the item information being acquired from the operational rule information; and
a decryption unit configured to decrypt the content data based on the decryption key information.

2. The terminal apparatus according to claim 1, wherein the reproduction object inherent information includes any one of a limit item concerning the content, a restriction item restricting at least one of the terminal apparatus and an item inherent to a user.

3. The terminal apparatus according to claim 1, wherein the operational rule information contains a flag indicative of the operational rule information which is independent on the reproduction object inherent information.

4. A terminal for decrypting encrypted data including content, comprising:
providing part configure to provide terminal-side item information;
a first memory part configured to receive and store operational rule information corresponding to a combination of title key and encrypted keyword information, the title key being uniquely determined in accordance with the content, and the encrypted keyword information being encrypted based on reproduction object inherent information restricting a reproduction object of content and including item information;
a second memory part configured to receive and store the encrypted content data encrypted based to on encryption key information generated from the title key and the reproduction object inherent information;
a decryption key generation unit configured to compare the key word information with the terminal-side item information to judge a reproduction possibility of the encrypted content data, and generate a decryption key from the item information and the title key in accordance with the judgment, the key word information being acquired from the operational rule information; and
a decryption unit configured to decrypt the content data based on the decryption key information.

5. The terminal apparatus according to claim 4, wherein the reproduction object inherent information includes any one of a limit item concerning a reproduction content, a restriction item which restricts the terminal apparatus and an item inherent to a user.

6. The terminal apparatus according to claim 4, wherein the operational rule information includes a flag indicative of the operational rule information which is independent on the reproduction object inherent information.

7. An encryption apparatus for encrypting content data, comprising:
a receiving portion configured to receive terminal-side item information from the outside of the apparatus;
a first generation portion configured to acquire a title key which is uniquely determined in accordance with each content and the terminal-side item information and generates reproduction object inherent information which restricts a reproduction object of content;
a second generation portion configured to generate an encryption key information based on the title key and the reproduction object inherent information;
an encryption portion configured to encrypt the content data with utilizing the encryption key information to generate a encryption content file; and
an output portion configured to generate an operational rule information file including the title key, and the reproduction object inherent information and outputs the operational rule information file.

8. The terminal apparatus according to claim 7, wherein the reproduction object inherent information includes any one of a limit item concerning a reproduction content, a restriction item which restricts the terminal apparatus and an item inherent to a user.

9. An encryption apparatus according to claim 7, wherein a flag indicative of the encryption key information which is independent on the reproduction object inherent information is provided in the operational rule information file.

10. An encryption apparatus for encrypting content data, comprising:
a receiving portion configured to receive terminal-side item information from the outside of the apparatus;
a first generation portion configured to acquire a title key which is uniquely determined in accordance with each content and the terminal-side item information and generates reproduction object inherent information which restricts a reproduction object of content;
a second generation portion configured to generate encryption key information based on the title key and the reproduction object inherent information, and generates encrypted keyword information obtained by encrypting the encryption key information based on the reproduction object inherent information;
an encryption portion configured to encrypt the content data with utilizing the encryption key information to generate a encrypted content file; and
an output portion configured to generate an operational rule information file including the title key, and the encrypted keyword information.

11. The terminal apparatus according to claim 10, wherein the reproduction object inherent information includes any one of a limit item concerning a reproduction content, a restriction item which restricts the terminal apparatus and an item inherent to a user.

12. The encryption apparatus according to claim 10, wherein a flag indicative of the encryption key information which is independent on the reproduction object inherent information is provided in the operational rule information.

13. A method of decrypting encrypted data including content, comprising:
preparing terminal-side item information;
receiving and storing operational rule information corresponding to a combination of title key and reproduction object inherent information, the title key being uniquely determined in accordance with the content, and the reproduction object inherent information restricting a reproduction object of content and including item information;
receiving and storing the encrypted content data encrypted based to on encryption key information generated from the title key and the reproduction object inherent information;
comparing the item information with the terminal-side item information to judge a reproduction possibility of the encrypted content data, and generating a decryption key from the item information and the title key in accordance with the judgment, the item information being acquired from the operational rule information; and
decrypting the content data based on the decryption key information.

14. The method according to claim 13, wherein the reproduction object inherent information includes any one of a limit item concerning the content, a restriction item restricting at least one of the terminal and an item inherent to a user.

15. The method according to claim 13, wherein the operational rule information contains a flag indicative of the operational rule information which is independent on the reproduction object inherent information.

16. A method of decrypting encrypted data including content, comprising:
providing terminal-side item information;
receiving and storing operational rule information corresponding to a combination of title key and encrypted keyword information, the title key being uniquely determined in accordance with the content, and the encrypted keyword information being encrypted based on reproduction object inherent information restricting a reproduction object of content and including item information;
receiving and storing the encrypted content data encrypted based to on encryption key information generated from the title key and the reproduction object inherent information;
comparing the key word information with the terminal-side item information to judge a reproduction possibility of the encrypted content data, and generating a decryption key from the item information and the title key in accordance with the judgment, the key word information being acquired from the operational rule information; and
decrypting the content data based on the decryption key information.

17. The method according to claim 16, wherein the reproduction object inherent information includes any one of a limit item concerning a reproduction content, a restriction item which restricts the terminal apparatus and an item inherent to a user.

18. The method according to claim 16, wherein the operational rule information includes a flag indicative of the operational rule information which is independent on the reproduction object inherent information.

19. An encryption method of encrypting content data, comprising:
receiving terminal-side item information from the outside;
acquiring a title key which is uniquely determined in accordance with each content and the terminal-side item information and generating reproduction object inherent information which restricts a reproduction object of content;
generating an encryption key information based on the title key and the reproduction object inherent information;
encrypting the content data with utilizing the encryption key information to generate a encryption content file; and
generating a operational rule information file including the title key, and the reproduction object inherent information and outputs the operational rule information file.

20. The encryption method according to claim 19, wherein the reproduction object inherent information includes any one of a limit item concerning a reproduction content, a restriction item which restricts the terminal apparatus and an item inherent to a user.

21. The encryption method according to claim 19, wherein a flag indicative of the encryption key information which is independent on the reproduction object inherent information is provided in the operational rule information file.

22. An encryption method of encrypting content data, comprising:
receiving terminal-side item information from the outside;
acquiring a title key which is uniquely determined in accordance with each content and the terminal-side item information and generating reproduction object inherent information which restricts a reproduction object of content;
generating encryption key information based on the title key and the reproduction object inherent information, and generating encrypted keyword information obtained by encrypting the encryption key information based on the reproduction inherent information;
encrypting the content data with utilizing the encryption key information; and
generating an operational rule information file including the title key, and the encrypted keyword information and outputting the operational rule information file.

23. The encryption method according to claim 22, wherein the reproduction object inherent information includes any one of a limit item concerning a reproduction content, a restriction item which restricts the terminal apparatus and an item inherent to a user.

24. The encryption method according to claim 23, wherein a flag indicative of the encryption key information which is independent on the reproduction object inherent information is provided in the operational rule information file.
